(19) United States
(12) Patent Application Publication
(10) Pub. No.: US 2017/0107423 A1
(43) Pub. Date: Apr. 20, 2017

(54) GELLING FLUIDS AND RELATED METHODS OF USE

(71) Applicant: RHODIA OPERATIONS, Paris (FR)

(72) Inventors: SueAnn LIM, Singapore (SG); Rose NDONG, Lawrenceville, NJ (US); Lingjuan SHEN, Langhorne, PA (US); Ahmed RABIE, Yardley, PA (US); Manilal S. DAHANAYAKE, Princeton Junction, NJ (US)

(73) Assignee: RHODIA OPERATIONS, Paris (FR)

(21) Appl. No.: 15/293,940

(22) Filed: Oct. 14, 2016

Related U.S. Application Data
(60) Provisional application No. 62/241,250, filed on Oct. 14, 2015.

(51) Int. Cl. C09K 8/74; E21B 43/25

(52) U.S. Cl. CPC C09K 8/74; E21B 43/25; C09K 2208/32

(57) ABSTRACT

Methods of acidizing a subterranean formation penetrated by a wellbore that include the steps of (a) injecting into the wellbore at a pressure below subterranean formation fracturing pressure a treatment fluid having a first viscosity and including an aqueous acid and a gelling agent of Formula II:

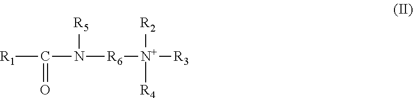

wherein R₁ is (CₓH_{y}), wherein x ranges from 17 to 21 and y=2x+1 or 2x−1; R₅ is hydrogen or —CH₃; R₆ is —CH₂—CH₂—CH₂—; and R₂, R₃, and R₄ are each —CH₃; (b) forming at least one void in the subterranean formation with the treatment fluid; and (c) allowing the treatment fluid to attain a second viscosity that is greater than the first viscosity.

### CROSS-REFERENCE TO RELATED APPLICATION

The present application claims the benefit of priority under 35 U.S.C. §119(e) of U.S. Provisional Application Ser. No. 62/241,250, filed on Oct. 14, 2015, the entire disclosure of which is incorporated herein by reference.

### BACKGROUND

There are several stimulation treatments for increasing oil production, such as hydraulic fracturing and matrix acidizing. Hydraulic fracturing includes pumping specially-engineered fluids at high pressures into the formation in order to create fissures that are held open by the proppants present in the fluid once the treatment is completed.

In contrast, matrix acidizing is used for low permeability formations. It is a common practice to acidize subterranean formations in order to increase the permeability thereof. For example, in the petroleum industry, it is conventional to inject an acidizing fluid into a well in order to increase the permeability of a surrounding hydrocarbon-bearing formation, thereby facilitating the flow of hydrocarbons into the well from the formation. Such acidizing techniques are generally referred to as matrix acidizing treatments.

In matrix acidizing, the acidizing fluid is passed into the formation from the well at a pressure below the breakdown pressure of the formation. In this case, increase in permeability is affected primarily by the chemical reaction of the acid within the formation with little or no permeability increase being due to mechanical disruptions within the formation as in fracturing.

### SUMMARY

Described herein are methods of acidizing a subterranean formation penetrated by a wellbore that include the steps of (a) injecting into the wellbore at a pressure below subterranean formation fracturing pressure a treatment fluid having a first viscosity and including an aqueous acid and a gelling agent of Formula II:

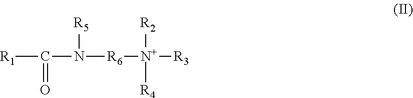

wherein R₁ is (CₓH_{y}), wherein x ranges from 17 to 21 and y=2x+1 or 2x−1; R₅ is hydrogen or —CH₃; R₆ is —CH₂—CH₂—CH₂—; and R₂, R₃, and R₄ are each —CH₃; (b) forming at least one void in the subterranean formation with the treatment fluid; and (c) allowing the treatment fluid to attain a second viscosity that is greater (e.g. more viscous) than the first viscosity. In some embodiments, the gelling agent is present in an amount from about 0.1 wt % to about 15 wt % by total weight of the fluid in step (a).

In some embodiments, the method further includes forming at least one void in the subterranean formation with the treatment fluid after the fluid has attained the second viscosity.

In some embodiments, the method further includes reducing the viscosity of the treatment fluid to a viscosity that is less than (e.g. less viscous) the second viscosity.

In some embodiments, the method further includes recovering at least a portion of the treatment fluid.

In some embodiments, the aqueous acid is selected from hydrochloric acid, hydrofluoric acid, formic acid, acetic acid, sulfamic acid, and combinations thereof.

In some embodiments, the treatment fluid further includes an alcohol selected from alkanols, alcohol alkoxylates, and combinations thereof.

In some methods, the treatment fluid further includes one or more additives selected from corrosion inhibitors, iron control agents, clay stabilizers, scale inhibitors, mutual solvents, non-emulsifiers, anti-slug agents, and combinations thereof.

In some methods the subterranean formation includes a sandstone formation. In some methods, the subterranean formation includes a carbonate formation.

### BRIEF DESCRIPTION OF DRAWINGS

FIG. 1 is a graph displaying apparent viscosity as a function of temperature for 6% gelling agent with and without acid additives;

FIG. 2 is a graph displaying pressure drop across the cores during the coreflood at 150° F.;

FIG. 3 is a CT-image of the cores after the dual coreflood at 150° F.: (a) high-permeability core, and (b) low-permeability core;

FIG. 4 is a graph displaying pressure drop across the cores during the coreflood at 250° F.; and

FIG. 5 is a CT-image of the cores after the dual coreflood at 250° F.: (a) high-permeability core, and (b) low-permeability core.

### DETAILED DESCRIPTION

The present disclosure relates to gelling fluids (e.g. treatment fluids) and related methods of use for acidizing a subterranean formation. As used herein, the term “subterranean formation” includes areas below exposed earth as well as areas below earth covered by water such as sea or ocean water. In some embodiments, the subterranean formation includes a carbonate formation. In carbonate formations, the goal is usually to have the acid dissolve the carbonate rock to form highly-conductive fluid flow channels in the formation rock. In acidizing a carbonate formation, calcium and magnesium carbonates of the rock can be dissolved with acid. A reaction between an acid and the minerals calcite (CaCO₃) or dolomite (CaMg(CO₃)₂) can enhance the fluid flow properties of the rock. In some embodiments, the subterranean formation includes a sandstone formation. Most sandstone formations are composed of over 50-70% sand quartz particles, i.e. silica (SiO₂) bonded together by various amounts of cementing material including carbonate (calcite or CaCO₃) and silicates.

In an embodiment, the gelling fluid includes a gelling agent of Formula I or II:

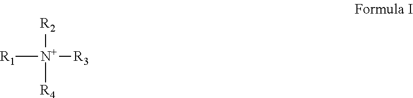

In Formula I, R₁ is a hydrocarbyl group that may be branched or straight-chain, aromatic, aliphatic or olefinic and contains from about 8 to about 30 carbon atoms. In an embodiment, R₁ is ethoxylated. R₂, R₃ and R₄ are the same or different and are alkyl or hydroxyalkyl of from 1 to about 5 carbon atoms, or R₃ and R₄ or R₂ together with the nitrogen atom to which they are bonded form a heterocyclic ring of up to 6 members.

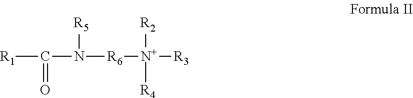

In Formula II, R₁ is a saturated or unsaturated, branched or straight-chain aliphatic or aromatic group of from about 8 to about 30 carbon atoms, R₅ is hydrogen or an alkyl or hydroxyalkyl group of from 1 to about 5 carbon atoms, R₆ is a saturated or unsaturated, straight or branched alkyl group of from 2 to about 6 carbon atoms, R₂, R₃ and R₄ are the same or different and are alkyl or hydroxyalkyl of from 1 to about 5 carbon atoms, or R₃ and R₄ or R₂ together with the nitrogen atom to which they are bonded form a heterocyclic ring of up to 6 members. In an embodiment, R₁ is (CₓH_{y}), wherein x ranges from 17 to 21 and y=2x+1 or 2x−1; R₅ is hydrogen or —CH₃; R₆ is —CH₂—CH₂—CH₂—; and R₂, R₃, and R₄ are each —CH₃.

In an embodiment, the gelling agent of Formula I is stearyl trimethyl ammonium chloride:

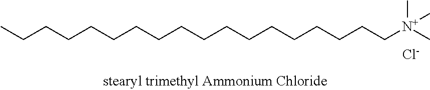 [SMILES: CCCCCCCCCCCCCCCCCC[N+](C)(C)C ; [Cl-]]

In an embodiment, the gelling agent of Formula II is erucyl amidopropyl trimethyl ammonium:

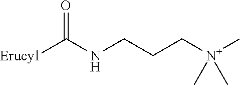

The gelling agent is present in an amount suitable for use in an acidizing process. In an embodiment, the gelling agent is present in an amount from about 0.1 wt % to about 15 wt % by total weight of the fluid. In another embodiment, the gelling agent is present in an amount from about 2.5 wt % to about 10 wt % by total weight of the fluid.

In an embodiment, the gelling fluid further includes at least one solvent selected from water, alcohols, and combinations thereof. In an embodiment, the gelling fluid includes an alcohol selected from monohydric alcohols, dihydric alcohols, polyhydric alcohols, and combinations thereof. In another embodiment, the gelling fluid includes an alcohol selected from alkanols, alcohol alkoxylates, and combinations thereof. In another embodiment, the gelling fluid includes an alcohol selected from methanol, ethanol, isopropanol, butanol, propylene glycol, ethylene glycol, polyethylene glycol, and combinations thereof.

Each individual solvent is present in the gelling fluid in an amount suitable for use in an acidizing process. In an embodiment, the amount of each individual solvent in the gelling fluid ranges from 0 wt % to about 30 wt % by total weight of the fluid, with the total amount of solvent in the formulation ranging from about 10 wt % to about 70 wt % by total weight of the fluid. In an embodiment, the gelling fluid includes a gelling agent according to Formula I in an amount of 45 wt %; isopropanol in an amount of 19 wt %; propylene glycol in an amount of 16 wt %; and water in an amount of 20 wt %, wherein the amounts are by total weight of the fluid.

Optionally, the gelling fluid further includes one or more additives. In an embodiment, the fluid includes one or more additives selected from corrosion inhibitors, iron control agents, clay stabilizers, calcium sulfate inhibitors, scale inhibitors, mutual solvents, non-emulsifiers, anti-slug agents and combinations thereof. In an embodiment, the corrosion inhibitor is selected from alcohols (e.g. acetylenics); cationics (e.g. quaternary ammonium salts, imidazolines, and alkyl pyridines); and nonionics (e.g. alcohol ethoxylates).

In an embodiment, a treatment fluid suitable for use in an acidizing process includes a gelling fluid and an aqueous acid. Suitable aqueous acids include those compatible with gelling agents of Formula I or II for use in an acidizing process. In an embodiment, the aqueous acid is selected from hydrochloric acid, hydrofluoric acid, formic acid, acetic acid, sulfamic acid, and combinations thereof. In an embodiment, the treatment fluid includes acid in an amount up to 30 wt % by total weight of the fluid.

Also provided is a method of acidizing a formation penetrated by a wellbore that includes the steps of injecting into the wellbore at a pressure below formation fracturing pressure a treatment fluid that includes a gelling fluid and an aqueous acid and allowing the treatment fluid to acidize the formation and/or self-divert into the formation. As used herein, the term, “self-divert” refers to a composition that viscosifies as it stimulates the formation and, in so doing, diverts any remaining acid into zones of lower permeability in the formation.

In an embodiment, a method of acidizing a subterranean formation penetrated by a wellbore includes the steps of (a) injecting into the wellbore at a pressure below subterranean formation fracturing pressure a treatment fluid having a first viscosity and comprising an aqueous acid and a gelling agent of Formula II:

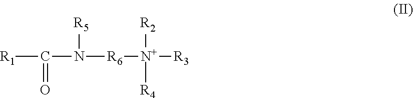

wherein R₁ is (CₓH_{y}), wherein x ranges from 17 to 21 and y=2x+1 or 2x−1; R₅ is hydrogen or —CH₃; R₆ is —CH₂—CH₂—CH₂—; and R₂, R₃, and R₄ are each —CH₃; (b) forming at least one void in the subterranean formation with the treatment fluid; and (c) allowing the treatment fluid to attain a second viscosity that is greater than the first viscosity. As used herein, the term “void(s)” is meant to encompass cracks, fractures, wormholes (e.g. highly branched flow channels), and the like. In another embodiment, the method further includes forming at least one void in the subterranean formation with the treatment fluid after the fluid has attained the second viscosity. In another embodiment, the method further includes reducing the viscosity of the treatment fluid to a viscosity that is less than the second viscosity. In another embodiment, the method further includes recovering at least a portion of the treatment fluid.

The methods and compositions of the present disclosure can be used in subterranean formations having a variety of operational conditions. For example, the methods and compositions of the present disclosure can be used in a variety of temperatures. In an embodiment, the step of forming at least one void in the subterranean formation with the treatment fluid occurs in a temperature range up to about 300° F. (149° C.). Besides a wide temperature range, the contact time in which the compositions are used can also be varied. In an embodiment, the step of forming at least one void in the subterranean formation with the treatment fluid can occur in a contact time that ranges from about one hour to several hours; or alternatively, from about one hour to about eight hours. Other process conditions that can be varied will be apparent to those of skill in the art and are to be considered within the scope of the present disclosure.

The present disclosure will further be described by reference to the following examples. The following examples are merely illustrative and are not intended to be limiting.

### EXAMPLES

### Example 1

### Treatment Fluid

A treatment fluid including a gelling agent according to Formula II in 20% HCl, which forms a homogenous low viscosity solution, was prepared. In general, when pumped into a subterranean formation, the acid reacts in the carbonate formation as shown in the reaction:

2HCl+CaCO3→CaCl2+H2O+CO2 (g)

The viscosity of the treatment fluid increases due to the presence of CaCl₂ and acid concentration (decrease in pH).

The treatment fluid was reacted with CaCO₃. Table 1 shows that the viscosity of the treatment fluid increases as the acid is spent. The percentage of acid spent is how much of the 20% HCl has reacted with CaCO₃. For example, 25% depletion means 5% HCl of the 20% HCl has reacted with the CaCO₃, resulting in about 7.5 wt. % CaCl₂ generated. The increased viscosity based upon the spending of the acid means the viscosity of the treatment fluid can be increased without additional products or chemical triggers.

TABLE 1
Viscosity of treatment fluid as acid is spent.

| Temper- | | | | | |
|---|---|---|---|---|---|
| ature | 20% HCl, | 20% HCl, | 20% HCl, | 20% HCl, | 20% HCl, |
| (deg. F.) | 0% spent | 25% spent | 50% spent | 75% spent | 100% spent |
| 100 | 6 | 37 | 90.6 | 81.5 | 317 |
| 125 | 6.2 | 30.7 | 93.5 | 92.7 | 462 |
| 150 | 6.6 | 24.8 | 97 | 84.4 | 670 |
| 175 | 7.2 | 21.3 | 95.7 | 88.5 | 796 |
| 200 | 7.6 | 19 | 88.2 | 89.4 | 329 |
| 225 | 9 | 20 | 82 | 70.6 | 338 |
| 250 | 19.2 | 29.8 | 75.6 | 51.6 | 230 |

### Example 2

### Treatment Fluid with Additives

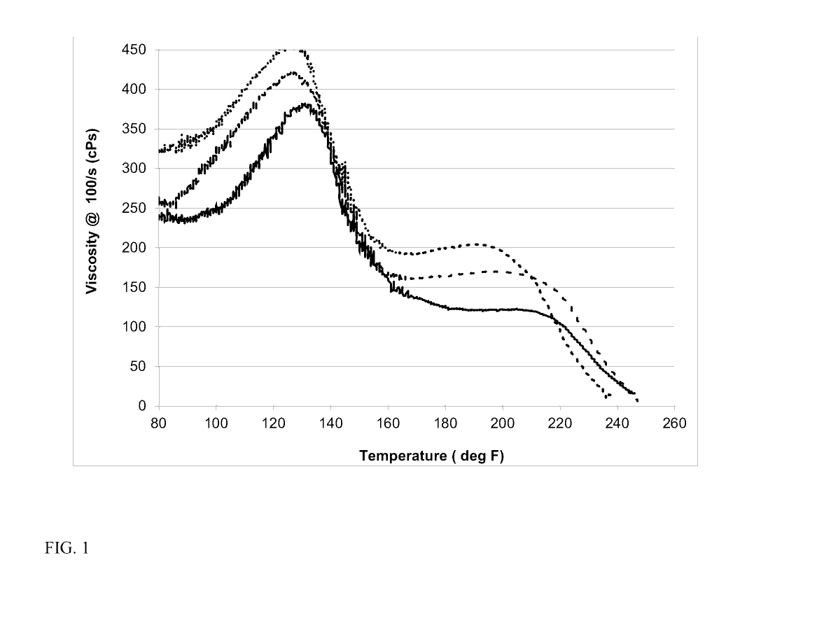

The compatibility of the gelling agent used in Example 1 in spent acid with other additives was investigated. The treatment fluid was prepared by blending the gelling agent in Example 1, acid additives (as needed) and CaCl₂ solution at high shear rate (7000-10000 rpm). The resulting blend was centrifuged to remove any bubbles. The obtained fluid was tested under pressure at a constant shear rate of 100/s using a high pressure, high temperate rheometer from room temperature to 250° F. FIG. 1 shows the compatibility of 6% of the gelling agent in 22.8 wt % CaCl₂, which corresponds to 15% HCl being totally spent. The solid line corresponds to the treatment fluid without additives; the dotted and dashed lines correspond to the treatment fluid with corrosion A and corrosion B, respectively in the presence of a non-emulsifier and chelating agent.

### Example 3

### Corrosion Study

In acidizing with strong acids, such as hydrochloric acid, corrosion is a major challenge to control especially at elevated temperatures. The corrosion rate of 15% HCl containing a 6 vol % of the gelling agent from Example 1 was determined in the presence of 10 gpt of three corrosion inhibitors. The corrosion rate was determined by the weight method using L-80 coupons at 250° F. after 6 hours. Table 2 shows a very acceptable level of protection against acid corrosion in the three cases and indicates an excellent compatibility of the treatment fluid of the present disclosure with the three corrosion inhibitors.

TABLE 2
Corrosion Data for 15% HCl containing a 6 vol % of
the gelling agent from Example 1 at 250° F.
after 6 hours with corrosion inhibitors A, B, and C.

| | Accepted | Corrosion | Corrosion | Corrosion | Corrosion |
|---|---|---|---|---|---|
| | corrosion | inhibitor | inhibitor | inhibitor | inhibitor |
| | limit | A | B | C | C* |
| Corrosion | 0.05 | 0.05 | 0.039 | 0.034 | 0.028 |
| rate lbₘ/ft² | | | | | |

*50 pptg KI was added as a corrosion intensifier

### Example 4

### Core Flood Experiment

A dual (parallel) core flood experiment was conducted at 150° F. to evaluate the ability of a gelling agent of the present disclosure to divert a treatment fluid in acidizing treatments. A dual core flood experiment imitates the injection of the treatment (e.g. stimulation) fluid into a formation with a contrast in permeability of its producing zones. In this case, acid diversion is required to ensure that the acid is flowing through, and hence, stimulating all zones.

Two Indiana limestone cores (1.5″ diameter×6″ length) representing high- and low-permeability layers were used. The properties of each core are listed in Table 3. The composition of the stimulation fluid is shown in Table 4. During the experiment, the pressure drop across both cores was recorded as a function of the injected pore volume. After the experiment, both cores were imaged using a CT-scan technique to visualize the extent and the structure of the created voids (e.g. wormholes) in each core.

TABLE 3
Initial properties of the two cores used in the coreflood at 150° F.

| | Core Pore | | Initial |
|---|---|---|---|
| Core | Volume, cm³ | Porosity, % | Permeability, md |
| High-Permeability | 20.7 | 12.0 | 7.67 |
| Low- Permeability | 25.07 | 14.4 | 4.82 |

TABLE 4
Acid composition used for the dual coreflood at 150° F.

| | | |
|---|---|---|
| HCl | 15 | wt % |
| Gelling agent (Example 1) | 6 | vol % |
| Corrosion Inhibitor A | 10 | gpt |
| Corrosion Intensifier (solid) | 50 | pptg |
| Non-emulsifier | 1 | gpt |
| Iron chelating agent | 1 | gpt |

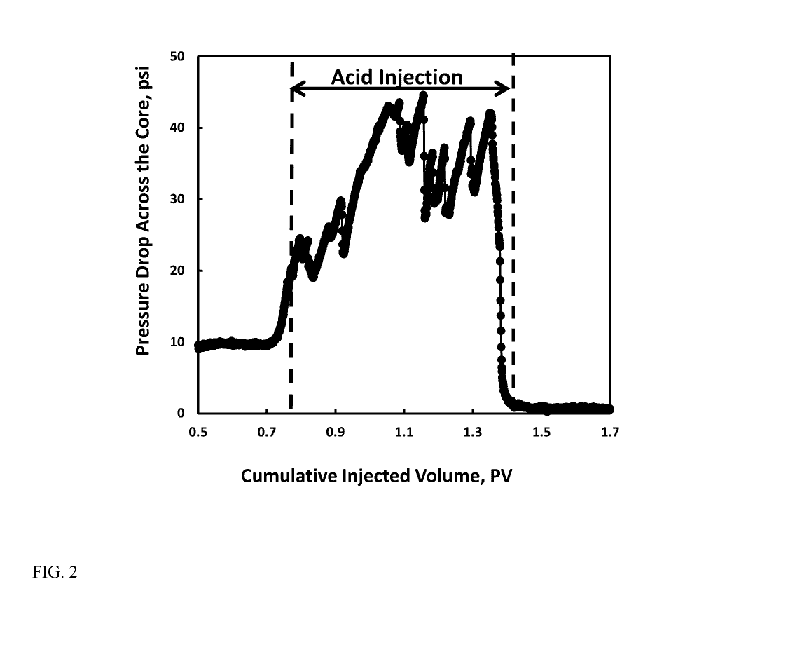

In this particular example, the recorded data showed an overall increase in the pressure drop from 9.5 psi to 44 psi during the acid injection, indicating a substantial increase in the fluid viscosity. The pressure drop profile also showed successive intervals of increase and decrease, which is a typical response for gel formation inside the core. When the acid reacts and spends, pH changes and sufficient calcium ions are produced, which trigger the alignment of the gelling agent into the rod-like micelles and build up the viscosity. This is accompanied with an increase in the pressure drop. The continuation of acid injection forces the acid to change the reaction path and open new voids/channels (wormhole) for flow. This is accompanied with a reduction in the pressure drop. Once the acid spends in the new channel and sufficient calcium is produced, the gelling agent builds up the viscosity and the pressure drop increases again. During this cycle, the overall increase in the pressure drop in the high-permeability core forces more flow into the low-permeability core and the diversion occurs. The pressure drop profile is shown in FIG. 2.

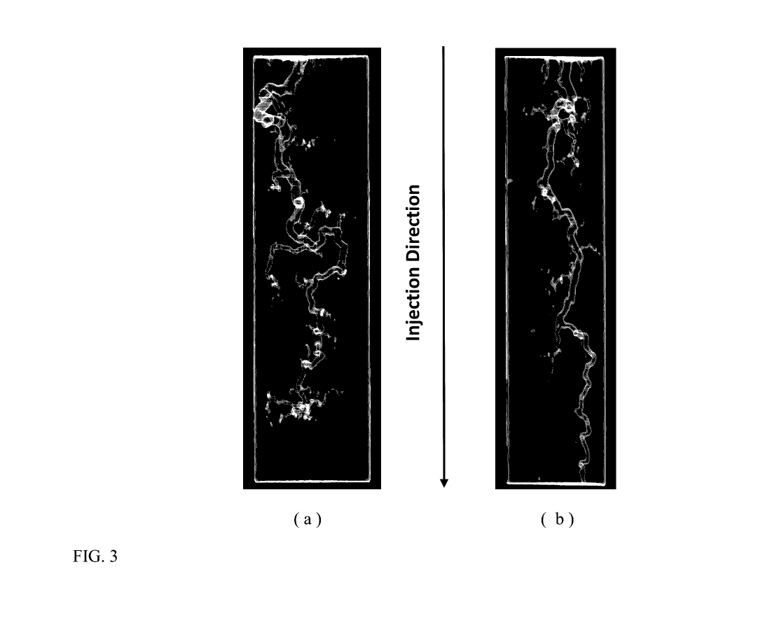

The post-treatment CT-scan imaging is shown in FIG. 3. and demonstrates that the acid injection resulted in a complete stimulation (breakthrough) in the low-permeability core and 84% stimulation (corresponded to a 5.04″ wormhole) in the high-permeability core. The results indicate that the majority of the initial stage of acid injection, which was flowing into the high-permeability core, was successful in diverting the acid into the low-permeability core and due to the definite length of each core (6 inch), a breakthrough occurred in the later. FIG. 3 also shows a significant degree of tortuosity in the high-permeability core indicating a successful gel formation that forced the acid to change the reaction path and flow in higher proportion into the low-permeability core.

### Example 5

### Coreflood Experiment

A second dual coreflood experiment was conducted at 250° F. The acid composition, based on corrosion inhibitor C, is shown in Table 5. Two Edward limestone cores with initial properties shown in Table 6 were used.

TABLE 5
Acid composition used for the dual coreflood at 150° F.

| | | |
|---|---|---|
| HCl | 15 | wt % |
| Gelling agent (Example 1) | 6 | vol % |
| Corrosion Inhibitor C | 10 | gpt |
| Corrosion Intensifier (liquid) | 40 | gpt |
| Non-emulsifier | 1 | gpt |
| Iron chelating agent | 1 | gpt |

TABLE 6
Initial properties of the two cores used in the coreflood at 250° F.

| | Core Pore | | Initial |
|---|---|---|---|
| Core | Volume, cm³ | Porosity, % | Permeability, md |
| High-Permeability | 33.2 | 19 | 6 |
| Low- Permeability | 40.0 | 22 | 3.8 |

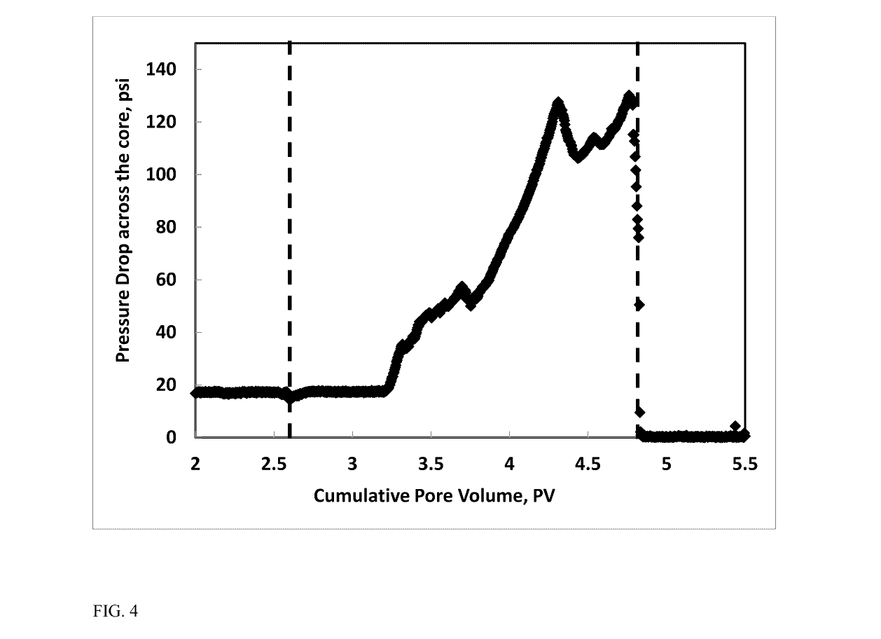

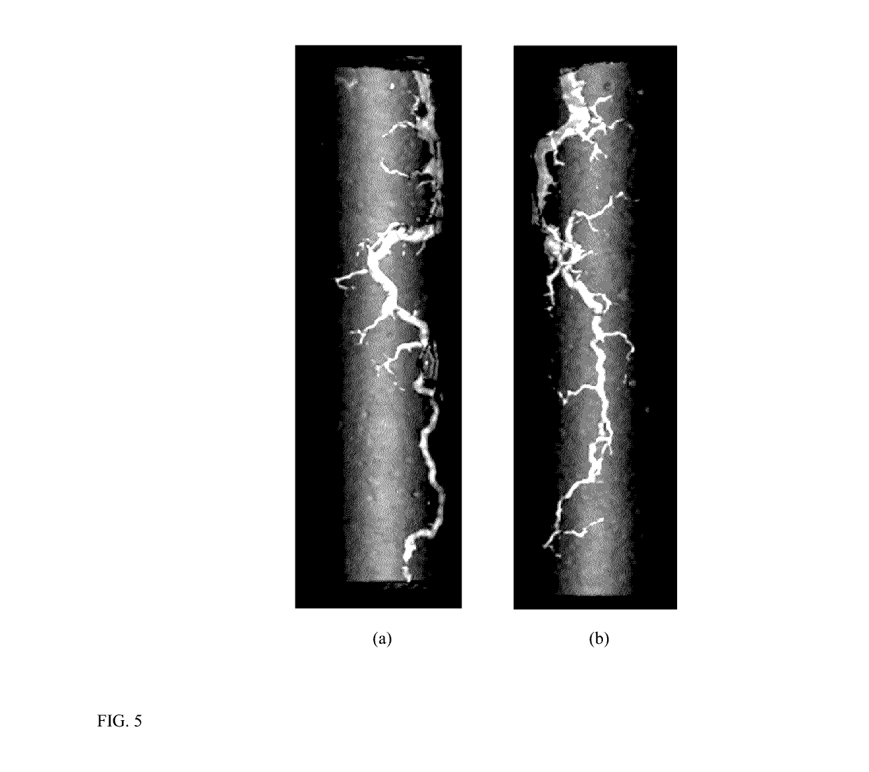

The pressure drop profile is depicted in FIG. 4, while the post-treatment CT-scan images are shown in FIG. 5. The data shows that the pressure drop increased from 19 to 130 psi indicating the viscosity build up and gel formation. The VES-based acid was successful in diverting the stimulation fluid with 90% stimulation in the low-permeability core and a breakthrough in the high-permeability core. As mentioned previously, the breakthrough in this type of experiments is because the definite length of the cores. The results show the applicability of the new VES as an effective diverting agent for acid treatments at at moderate and elevated temperatures.

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition. If there is any conflict in the usages of a word or term in this specification and one or more patent or other documents that may be incorporated herein by reference, the definitions that are consistent with this specification should be adopted.

We claim:

1. A method of acidizing a subterranean formation penetrated by a wellbore comprising the steps of (a) injecting into the wellbore at a pressure below subterranean formation fracturing pressure a treatment fluid having a first viscosity and comprising an aqueous acid and a gelling agent of Formula II: 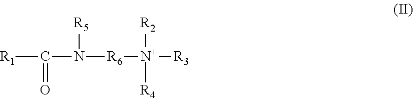
wherein R₁ is (CₓH_{y}), wherein x ranges from 17 to 21 and y=2x+1 or 2x−1; R₅ is hydrogen or —CH₃; R₆ is —CH₂—CH₂—CH₂—; and R₂, R₃, and R₄ are each —CH₃; (b) forming at least one void in the subterranean formation with the treatment fluid; and (c) allowing the treatment fluid to attain a second viscosity that is greater than the first viscosity.

2. The method of claim 1 further comprising forming at least one void in the subterranean formation with the treatment fluid after the fluid has attained the second viscosity.

3. The method of claim 2 further comprising reducing the viscosity of the treatment fluid to a viscosity that is less than the second viscosity.

4. The method of claim 3 further comprising recovering at least a portion of the treatment fluid.

5. The method of claim 1, wherein the gelling agent is present in an amount from about 0.1 wt % to about 15 wt % by total weight of the fluid in step 1(a).

6. The method of claim 1, wherein the aqueous acid is selected from the group consisting of hydrochloric acid, hydrofluoric acid, formic acid, acetic acid, sulfamic acid, and combinations thereof.

7. The method of claim 1, wherein the treatment fluid further comprises an alcohol selected from the group consisting of alkanols, alcohol alkoxylates, and combinations thereof.

8. The method of claim 1, wherein the treatment fluid further comprises one or more additives selected from the group consisting of corrosion inhibitors, iron control agents, clay stabilizers, scale inhibitors, mutual solvents, non-emulsifiers, anti-slug agents, and combinations thereof.

9. The method of claim 1, wherein the subterranean formation comprises a sandstone formation.

10. The method of claim 1, wherein the subterranean formation comprises a carbonate formation.
